(19) United States
(12) Patent Application Publication
(10) Pub. No.: US 2023/0231256 A1
(43) Pub. Date: Jul. 20, 2023

(54) NECK-MOUNTED POWER BANK

(71) Applicant: HTC Corporation, Taoyuan City (TW)

(72) Inventors: Peng Kuang Chen, Taoyuan City (TW); Wei-Cheng Liu, Taoyuan City (TW); Chun-Lung Chu, Taoyuan City (TW)

(73) Assignee: HTC Corporation, Taoyuan City (TW)

(21) Appl. No.: 17/737,028

(22) Filed: May 5, 2022

Related U.S. Application Data
(60) Provisional application No. 63/300,271, filed on Jan. 18, 2022.

(51) Int. Cl. H01M 50/247; H01M 10/42

(52) U.S. Cl. CPC H01M 50/247; H01M 10/425; H01M 2220/30; H01M 2010/4271

(57) ABSTRACT

A neck-mounted power bank includes a neck-mounted portion, a first body and a second body. The first body is connected to an end of the neck-mounted portion. The second body is connected to another end of the neck-mounted portion. The neck-mounted portion, the first body and the second body define a wearing space. The first body includes a first tray and a first controller. The first tray is connected to the neck-mounted portion. The first controller is detachable and electrically connected to the first tray, and has a first controller battery. When the first controller is installed and electrically connected to the first tray, the first controller battery can supply power to an electronic device through the first tray. When the first controller is detached from the first tray, the first controller can control the electronic device wirelessly.

### CROSS-REFERENCE TO RELATED APPLICATION

This application claims the priority benefit of U.S. provisional application Ser. No. 63/300,271, filed on Jan. 18, 2022. The entirety of the above-mentioned patent application is hereby incorporated by reference herein and made a part of this specification.

### BACKGROUND

### Technical Field

The application relates to a power bank, and in particular, to a neck-mounted power bank.

### Description of Related Art

With the increasing development of the technology industry, the types, functions and ways of use of display devices are becoming more and more diverse, and head-mounted display devices that can be directly worn on the user's body are also developed accordingly. When using the head-mounted display device, the head-mounted display device needs to be worn on the user's head. In order to facilitate the user's activities, the head-mounted display device is designed with a separate battery, so as to make the head-mounted display device lightweight.

### SUMMARY

The present application provides a neck-mounted power bank, which is combined with a battery and a controller to supply power to an electronic device and wirelessly control the electronic device.

The neck-mounted power bank of the present application is adapted to provide power to an electronic device and wirelessly control the electronic device. The neck-mounted power bank includes a neck-mounted portion, a first body and a second body. The first body is connected to an end of the neck-mounted portion. The second body is connected to another end of the neck-mounted portion. The neck-mounted portion, the first body and the second body define a wearing space. The first body includes a first tray and a first controller. The first tray is connected to the neck-mounted portion. The first controller is detachable and electrically connected to the first tray, and has a first controller battery. When the first controller is installed and electrically connected to the first tray, the first controller battery can supply power to an electronic device through the first tray. When the first controller is detached from the first tray, the first controller can control the electronic device wirelessly.

Based on the above, the neck-mounted power bank of the present application combines the battery and the controller at the same time. When the neck-mounted power bank is connected to the electronic device through a power transmission cable, the battery can supply power to the electronic device. When the controller of the neck-mounted power bank is detached from its tray, the controller can wirelessly control the electronic device. Therefore, users only need to carry a single accessory to obtain the functions of charging and wireless control at the same time.

### BRIEF DESCRIPTION OF THE DRAWINGS

FIG. 1A is a schematic diagram of a neck-mounted power bank according to an embodiment of the present invention.

FIG. 1B is a schematic diagram of another viewing angle of the neck-mounted power bank of FIG. 1A.

FIG. 2 is a schematic diagram of charging and controlling an electronic device by a neck-mounted power bank according to an embodiment of the present invention.

FIG. 3A is a schematic diagram of the first body of FIG. 1A.

FIG. 3B is a schematic diagram of the second body of FIG. 1A.

FIG. 4 is a schematic diagram of a neck-mounted power bank according to another embodiment of the present invention.

### DESCRIPTION OF THE EMBODIMENTS

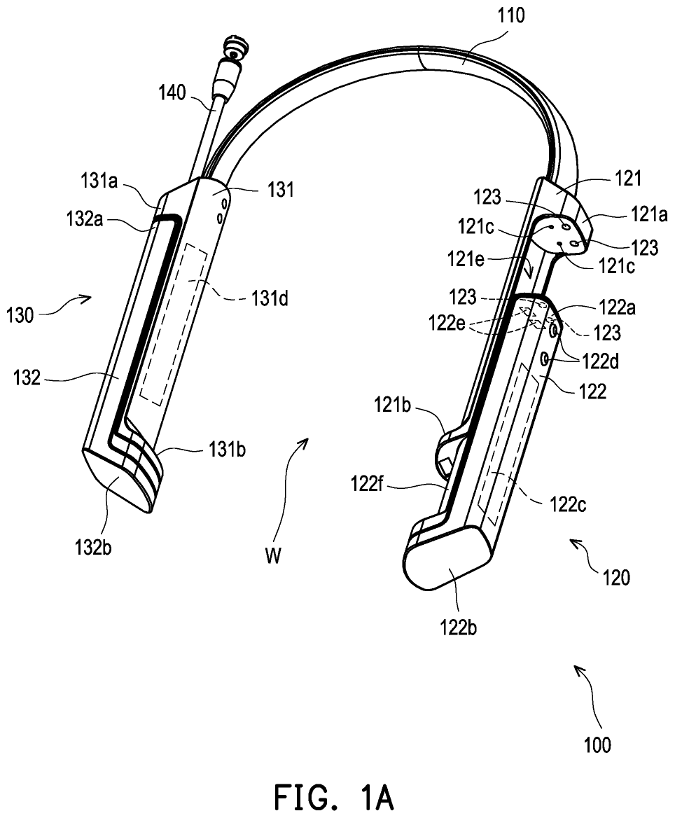

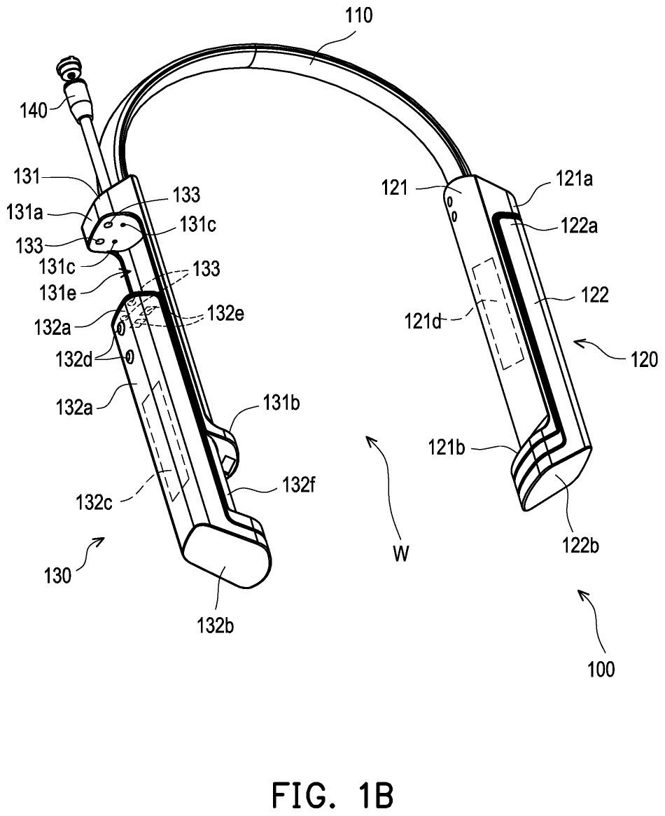

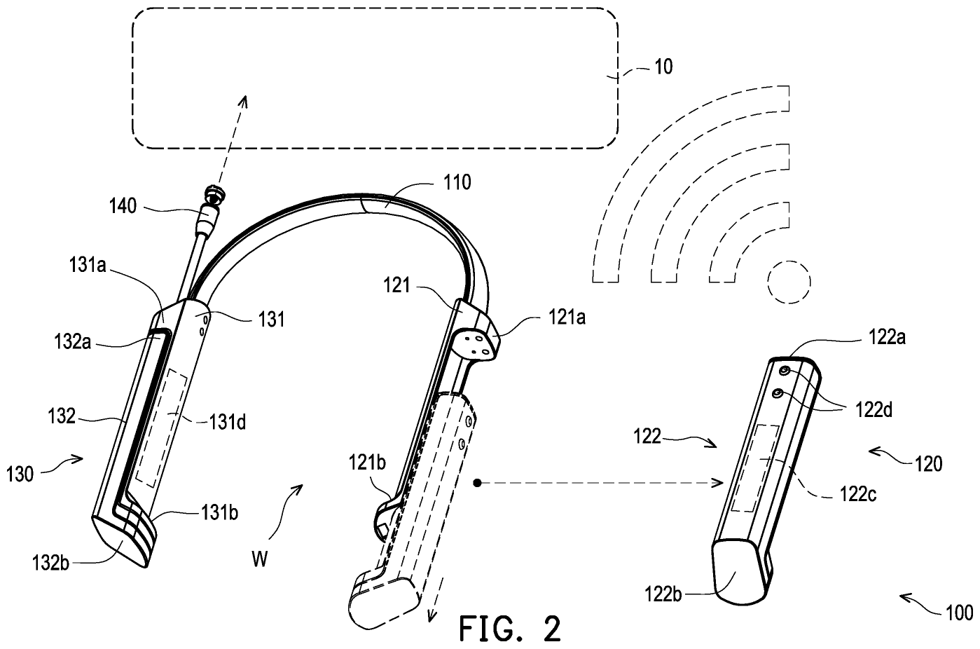

Referring to FIG. 1A, FIG. 1B and FIG. 2 at the same time, the neck-mounted power bank 100 of the embodiment is adapted to provide power to an electronic device 10 and wirelessly control the electronic device 10. The electronic device 10 is, for example, a head-mounted display device. The neck-mounted power bank 100 includes a neck-mounted portion 110, a first body 120 and a second body 130. The first body 120 is connected to an end of the neck-mounted portion 110, and the second body 130 is connected to another end of the neck-mounted portion 110. The neck-mounted portion 110, the first body 120 and the second body 130 define a wearing space W, and the first body 120 and the second body 130 are electrically connected to each other through the neck-mounted portion 110. In the embodiment, the neck-mounted power bank 100 is, for example, hung on the neck of the user, and the wearing space W corresponds to the neck of the user.

In the embodiment, the first body 120 includes a first tray 121 and a first controller 122. The first tray 121 is connected to the neck-mounted portion 110 and may have a first tray battery 121d. The first controller 122 is detachably and electrically connected to the first tray 121 and has a first controller battery 122c. When the first controller 122 is installed and electrically connected to the first tray 121, the first controller battery 122c can supply power to the electronic device 10 through the first tray 121. When the first controller 122 is detached from the first tray 121, the first controller 122 can wirelessly control the electronic device 10. At this time, the first tray battery 121d can supply power to the electronic device 10.

In the embodiment, the neck-mounted power bank 100 may include a power transmission cable 140. One end of the power transmission cable 140 is connected to the second body 130, and the other end of the power transmission cable 140 is connected to the electronic device 10. In other embodiments, one end of the power transmission cable 140 may also be connected to the first body 120, and the other end of the power transmission cable 140 may be connected to the electronic device 10.

In the embodiment, the second body 130 may include a second tray 131 and a second controller 132. The second tray 131 is connected to the neck-mounted portion 110 and may have a second tray battery 131d. The second controller 132 is detachably and electrically connected to the second tray 131 and has a second controller battery 132c. When the second controller 132 is installed and electrically connected to the second tray 131, the second controller battery 132c can supply power to the electronic device 10 through the second tray 131. When the second controller 132 is detached from the first tray 121, the second controller 132 can wirelessly control the electronic device 10. At this time, the second tray battery 131d can supply power to the electronic device 10.

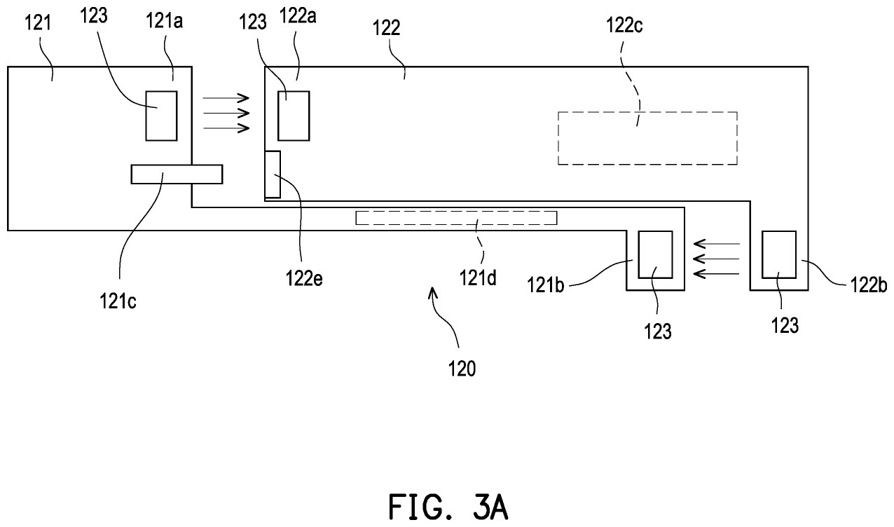

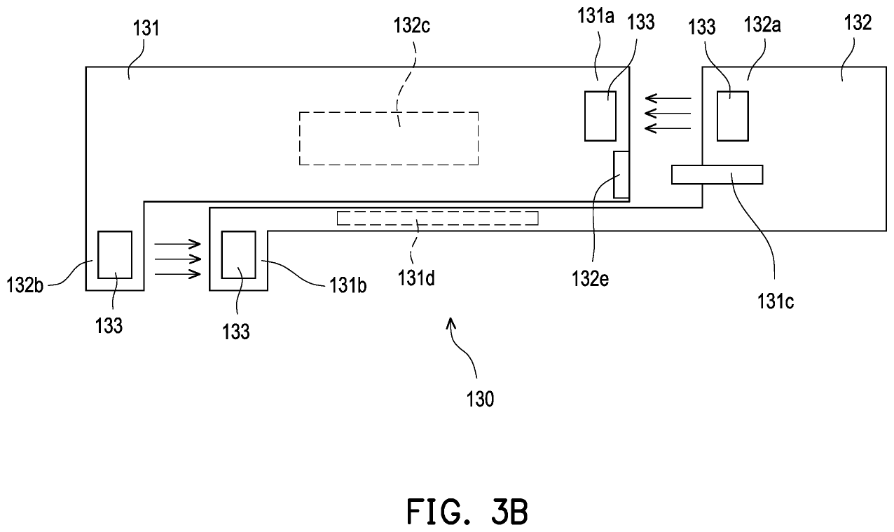

Referring to FIG. 1A, FIG. 2 and FIG. 3A at the same time, the first tray 121 may have a first tray upper end 121a and a first tray lower end 121b. The first tray upper end 121a and the first tray lower end 121b are located at opposite ends of the first tray 121. The first controller 122 may also have a first controller upper end 122a and a first controller lower end 122b. The first controller upper end 122a and the first controller lower end 122b are located at opposite ends of the first controller 122 respectively. The first body 120 may further include a plurality of first magnetic parts 123. The first magnetic parts 123 are respectively arranged on the first tray upper end 121a, the first tray lower end 121b, the first controller upper end 122a and the first controller lower end 122b, so that the first tray upper end 121a and the first controller upper end 122a are magnetically attracted to each other, and the first tray lower end 121b and the first controller lower end 122b are magnetically attracted to each other. That is, the first controller 122 and the first tray 121 are magnetically attracted to each other by the first magnetic parts 123, so that the first controller 122 is connected to the first tray 121.

In the embodiment, the first tray 121 may further have a first concave portion 121e. The first concave portion 121e is located between the first tray upper end 121a and the first tray lower end 121b. The first controller 122 may further have a first protruding portion 122f matched with the first concave portion 121e. The first protruding portion 122f is located between the first controller upper end 122a and the first controller lower end 122b. When the first controller 122 is to be connected to the first tray 121, the first protruding portion 122f may be aligned with the first concave portion 121e, and then the first controller 122 is slide in a direction from the first tray lower end 121b to the first tray upper end 121a. At this time, the first controller upper end 122a and the first controller lower end 122b are magnetically attracted by the first tray upper end 121a and the first tray lower end 121b respectively, so that the first controller 122 is connected to the first tray 121. In this state, the first protruding portion 122f and the first concave portion 121e fit with each other, and the first controller 122 is temporarily fixed on the first tray 121. In other embodiments, the first controller 122 and the first tray 121 can also be combined with each other through a snap structure or other mechanical structures.

When the first controller 122 is to be separated from the first tray 121, it is only necessary to slide the first controller 122 in the direction from the first tray upper end 121a to the first tray lower end 121b. The first controller 122 can be separated from the first tray 121 until the first protruding portion 122f moves away from the first concave portion 121e.

In the embodiment, the first tray 121 may further have a plurality of first pogo pins 121c. The first pogo pins 121c are located on the first tray upper end 121a. The first controller 122 may also have a plurality of first electrodes 122e. The first electrodes 122e may be located on the first controller upper end 122a. When the first controller 122 is installed on the first tray 121, the first pogo pins 121c are elastically contacted with the first electrodes 122e respectively to electrically connect the first controller 122 and the first tray 121 to each other. In addition, the first controller 122 may also have a plurality of first buttons 122d for controlling the electronic device 10.

Referring to FIG. 1B and FIG. 3B at the same time, in the embodiment, the second tray 131 may have a second tray upper end 131a and a second tray lower end 131b. And the second tray upper end 131a and the second tray lower end 131b are located at opposite ends of the second tray 131 respectively. The second controller 132 may also have a second controller upper end 132a and a second controller lower end 132b. And the second controller upper end 132a and the second controller lower end 132b are located at opposite ends of the second controller 132 respectively. The second body 130 may further include a plurality of second magnetic parts 133. The second magnetic parts 133 are respectively arranged on the second tray upper end 131a, the second tray lower end 131b, the second controller upper end 132a and the second controller lower end 132b, so that the second tray upper end 131a and the second controller upper end 132a are magnetically attracted to each other, and the second tray lower end 131b and the second controller lower end 132b are magnetically attracted to each other. That is, the second controller 132 and the second tray 131 are magnetically attracted to each other by the second magnetic parts 133, so that the second controller 132 is connected to the second tray 131.

In the embodiment, the second tray 131 may further have a second concave portion 131e, wherein the second concave portion 131e is located between the second tray upper end 131a and the second tray lower end 131b. The second controller 132 may further have a second protruding portion 132f matched with the second concave portion 131e, wherein the second protruding portion 132f is located between the second controller upper end 132a and the second controller lower end 132b. When the second controller 132 is to be connected to the second tray 131, the second protruding portion 132f may be aligned with the second concave portion 131e, and then the second controller 132 is slide in the direction from the second tray lower end 13 1 b to the second tray upper end 131a. At this time, the second controller upper end 132a and the second controller lower end 132b are magnetically attracted by the second tray upper end 131a and the second tray lower end 13 1 b respectively, so that the second controller 132 is connected to the second tray 131. In this state, the second protruding portion 132f and the second concave portion 131e fit with each other, and the second controller 132 is temporarily fixed on the second tray 131. In other embodiments, the second controller 132 and the second tray 131 can also be combined with each other through a snap structure or other mechanical structures.

When the second controller 132 is to be separated from the second tray 131, it is only necessary to slide the second controller 132 in the direction from the second tray upper end 131a to the second tray lower end 131b. The second controller 132 can be separated from the second tray 131 until the second protruding portion 132f moves away from the second concave portion 131e.

In the embodiment, the second tray 131 may further have a plurality of second pogo pins 131c. The second pogo pins 131c are located on the second tray upper end 131a. The second controller 132 may also have a plurality of second electrodes 132e. The second electrodes 132e may be located on the second controller upper end 132a. When the second controller 132 is installed on the second tray 131, the second pogo pins 131c are elastically contacted with the second electrodes 132e respectively to electrically connect the second controller 132 and the second tray 131 to each other. In addition, the second controller 132 may also have a plurality of second buttons 131d for controlling the electronic device 10.

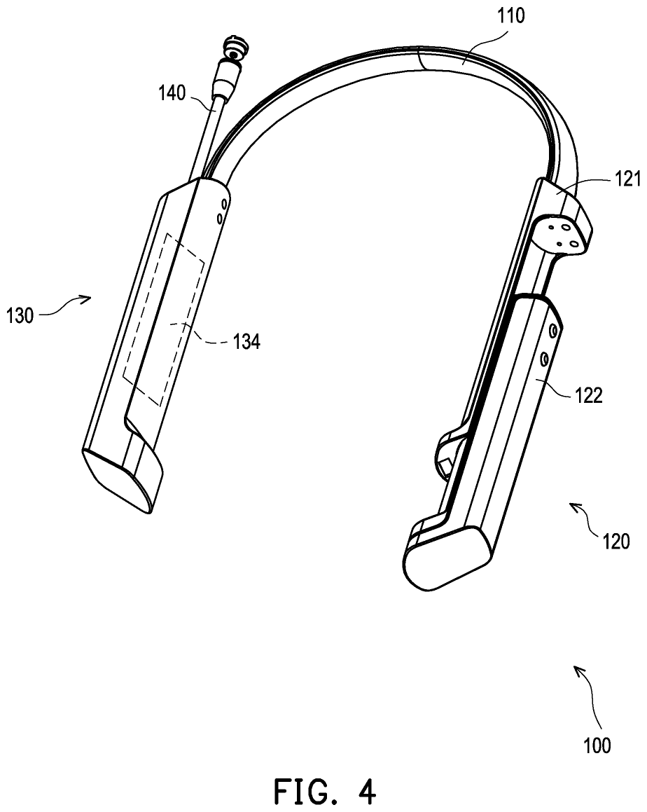

Referring to FIG. 4. Another embodiment of FIG. 4 is substantially the same as the embodiment of FIG. 1A. The difference between the two is that the second body 130 of the neck-mounted power bank 100 of FIG. 1A is different from the second body 130 of the neck-mounted power bank 100 of FIG. 4. In the embodiment of FIG. 4, the second body 130 includes a body battery 134, and the second body 130 does not include a detachable second controller (such as the second controller 132 in FIG. 1A). When the first controller 122 is detached from the first tray 121, the body battery 134 of the neck-mounted power bank 100 can supply power to the electronic device 10.

To sum up, the neck-mounted power bank of the present application combines a battery and a controller at the same time. When the neck-mounted power bank is connected to the electronic device through a wire, the battery can supply power to the electronic device. When the controller of the neck-mounted power bank is detached from its tray, the controller can wirelessly control the electronic device. Therefore, users only need to carry a single accessory to obtain the functions of charging and wireless controller at the same time. When the neck-mounted power bank is applied to the head-mounted display device, the battery of the neck-mounted power bank can supply power to the head-mounted display device. Therefore, the head-mounted display device may be equipped with only a low-capacity battery or no battery, in order to reduce the weight of the head-mounted display device. Meanwhile, the controller of the neck-mounted power bank can wirelessly control the head-mounted display device, thereby reducing the number of accessories required by the head-mounted display device.

What is claimed is:

1. A neck-mounted power bank, adapted to provide power to an electronic device and wirelessly control the electronic device, the neck-mounted power bank comprising:
a neck-mounted portion;
a first body, connected to an end of the neck-mounted portion; and
a second body, connected to another end of the neck-mounted portion, wherein the neck-mounted portion, the first body and the second body define a wearing space,
wherein the first body comprises:
a first tray, connected to the neck-mounted portion; and
a first controller, detachably and electrically connected to the first tray, and the first controller has a first controller battery,
wherein when the first controller is installed and electrically connected to the first tray, the first controller battery can supply power to an electronic device through the first tray, and when the first controller is detached from the first tray, the first controller can control the electronic device wirelessly.

2. The neck-mounted power bank according to claim 1, wherein the first body and the second body are electrically connected to each other through the neck-mounted portion.

3. The neck-mounted power bank according to claim 1, further comprises:
a power transmission cable, one end of the power transmission cable is connected to the first body or the second body, and the other end of the power transmission cable is connected to the electronic device.

4. The neck-mounted power bank according to claim 1, wherein the first tray further has a first tray upper end and a first tray lower end, the first tray upper end is connected to the neck-mounted portion, the first controller further has a first controller upper end and a first controller lower end, and when the first controller is installed on the first tray, the first controller upper end is fitted with the first tray upper end, and the first controller lower end is fitted with first tray lower end.

5. The neck-mounted power bank according to claim 4, wherein the first tray further has a first concave portion, the first concave portion is located between the first tray upper end and the first tray lower end, the first controller further has a first protruding portion, the first protruding portion is located between the first controller upper end and the first controller lower end, and the first concave portion is matched with the first protruding portion.

6. The neck-mounted power bank according to claim 4, wherein the first body further comprises:
a plurality of first magnetic parts, respectively arranged on the first tray upper end, the first tray lower end, the first controller upper end and the first controller lower end, so that the first tray upper end and the first controller upper end are magnetically attracted to each other, and the first tray lower end and the first controller lower end are magnetically attracted to each other.

7. The neck-mounted power bank according to claim 1, wherein the first tray has a plurality of first pogo pins, and the plurality of first pogo pins are located on the first tray, the first controller further has a plurality of first electrodes, and when the first controller is installed on the first tray, the plurality of first pogo pins are elastically contacted with the plurality of first electrodes respectively to electrically connect the first controller and the first tray to each other.

8. The neck-mounted power bank according to claim 1, wherein the first controller further has a plurality of first buttons.

9. The neck-mounted power bank according to claim 1, wherein the second body further comprises:
a second tray, connected to another end of the neck-mounted portion; and
a second controller, detachably and electrically connected to the second tray.

10. The neck-mounted power bank according to claim 9, wherein the second tray further has a second tray upper end and a second tray lower end, the second tray upper end is connected to the neck-mounted portion, the second controller further has a second controller upper end and a second controller lower end, and when the second controller is installed on the second tray, the second controller upper end is fitted with the second tray upper end, and the second controller lower end is fitted with second tray lower end.

11. The neck-mounted power bank according to claim 10, wherein the second tray further has a second concave portion, the second concave portion is located between the second tray upper end and the second tray lower end, the second controller further has a second protruding portion, the second protruding portion is located between the second controller upper end and the second controller lower end, and the second concave portion is matched with the second protruding portion.

12. The neck-mounted power bank according to claim 10, wherein the second body further comprises:
a plurality of second magnetic parts, respectively arranged on the second tray upper end, the second tray lower end, the second controller upper end and the second controller lower end, so that the second tray upper end and the second controller upper end are magnetically attracted to each other, and the second tray lower end and the second controller lower end are magnetically attracted to each other.

13. The neck-mounted power bank according to claim 9, wherein the second tray has a plurality of second pogo pins, and the plurality of second pogo pins are located on the second tray, the second controller further has a plurality of second electrodes, and when the second controller is installed on the second tray, the plurality of second pogo pins are elastically contacted with the plurality of second electrodes respectively to electrically connect the second controller and the second tray to each other.

14. The neck-mounted power bank according to claim 9, wherein the second body further comprises:
a second tray battery is arranged in the second tray and can supply power to the electronic device.

15. The neck-mounted power bank according to claim 9, wherein the second controller further has a plurality of second buttons.

16. The neck-mounted power bank according to claim 1, wherein the first body further comprises:
a first tray battery is arranged in the first tray and can supply power to the electronic device.

17. The neck-mounted power bank according to claim 1, wherein the second body has a body battery, and the body battery can supply power to the electronic device.
